(19) United States
(12) Patent Application Publication
(10) Pub. No.: US 2020/0327549 A1
(43) Pub. Date: Oct. 15, 2020

(54) Robust and Adaptive Artificial Intelligence Modeling

(71) Applicant: PAYPAL, INC., San Jose, CA (US)

(72) Inventors: Yanzan Zhou, San Jose, CA (US); Shuoyuan Wang, Shanghai (CN); Wei Zhao, Shanghai (CN); Ying Chen, Fremont, CA (US)

(21) Appl. No.: 15/775,980

(22) PCT Filed: Nov. 8, 2017
(86) PCT No.: PCT/CN2017/109957

§ 371 Date: May 14, 2018

(51) Int. Cl. G06Q 20/40; G06N 3/04; G06N 20/20

(52) U.S. Cl. CPC G06Q 20/4016; G06Q 20/4093; G06N 20/20; G06N 3/04

(57) ABSTRACT

A particular machine learning architecture involving a two-part artificial intelligence (AI) model is disclosed, with one portion being trained on first data (e.g. older data) and another portion being trained on second data (e.g. newer data) in various embodiments. A robust AI model can be combined with an adaptive AI model to account for long-term trends as well as newly emerging population trends. The model architecture can be constructed using gradient boosting trees, artificial neural networks, or other machine learning models. The adaptive AI model can be re-trained on a more frequent basis than the robust AI model, and can use newer types of data in its classification techniques. The adaptive and robust AI models can be combined using logistic regression to provide unified predictions. Electronic transactions and other types of data subject to potential pattern shifts can thus be more accurately classified.

### CROSS-REFERENCE TO RELATED APPLICATIONS

This application claims priority to and the benefit of International Patent Application No. PCT/CN2017/109957 filed on Nov. 8, 2017, the contents of which are hereby incorporated by reference herein in its entirety.

### TECHNICAL FIELD

This disclosure relates to data processing using machine learning and artificial intelligence. More particularly, this disclosure relates to a particular machine learning architecture involving a two-part model, with one portion being trained on first data (e.g. older data having particular features) and another portion being trained on second data (e.g. at least some newer data, which may have one or more different features).

### BACKGROUND

Automatic classification of data is a challenging problem, particularly when that data may have shifting patterns driven by evolving usage. While data may be classified into either a category A or a category B, for example, as time goes on, the population of the underlying data may start to change in its characteristics such that the performance of a categorization model deteriorates. Thus, certain model-based categorization approaches suffer from inefficiencies and can provide sub-optimal results.

### BRIEF DESCRIPTION OF THE DRAWINGS

FIG. 1 illustrates a block diagram of a system that includes users devices, a machine learning system, a transaction system, a network, and a records database according to some embodiments.

FIG. 2 illustrates a block diagram of a set of data records, according to some embodiments.

FIG. 3 illustrates a block diagram relating to a combined artificial intelligence (AI) model that includes both a robust and an adaptive component, according to some embodiments.

FIG. 4 illustrates a chart diagram of a logistic regression table relating to classification accuracy, according to some embodiments.

FIG. 5 illustrates a flow diagram is shown of a method that relates to constructing, training, and operating an AI system that includes a robust AI model and an adaptive AI model, according to some embodiments.

FIG. 6 is a diagram of a computer readable medium, according to some embodiments.

FIG. 7 is a block diagram of a system, according to some embodiments.

### DETAILED DESCRIPTION

When a categorization model degrades in performance, it can be updated with fresh data to try to obtain better performance. Updating a categorization model can be a time-consuming and resource intensive proposition, however. It can also be difficult to determine when a model should be updated. If an arbitrary time period is chosen that is relatively short (e.g., every 2 weeks), the model may become overly sensitive to short term trends, and also incur significant resource usage during the frequent updates. If a longer time period is chose (e.g., every 2 years), the model's performance may seriously degrade by the end of the cycle time, as certain pattern shifts might not be captured or only be captured after they become less relevant.

The present specifications describes an architecture, in various embodiments, that includes a two-part system, with a robust artificial intelligence model and an adaptive artificial intelligence model. The robust model may be trained less frequently using more mature (older) data while the adaptive model may be trained more often using less mature (newer) data, which in some cases may include different features than the data used to train the robust model, in various embodiments. A combined ensemble model based on both the robust model and the adaptive model may then be used to make predictions.

This architecture allows for more accurate classification of data, particularly when the underlying data shifts over time. Thus, in some instances, classification of electronic transactions can be performed using this robust and adaptive artificial intelligence model.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.).

Various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

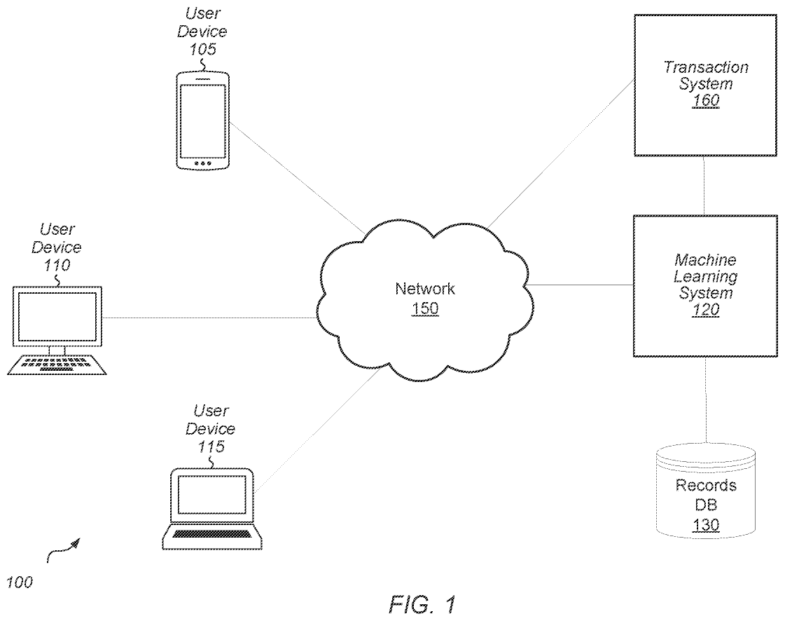

Turning to FIG. 1, a block diagram of a system 100 is shown. In this diagram, system 100 includes user devices 105, 110, 115, a machine learning system 120, a transaction system 160, and a network 150. Also depicted is records DB (database) 130. Note that other permutations of this figure are contemplated (as with all figures). While certain connections are shown (e.g. data link connections) between different components, in various embodiments, additional connections and/or components may exist that are not depicted. Further, components may be combined with one other and/or separated into one or more systems.

User devices 105, 110, and 115 may be any type of computing device. Thus, these devices can be a smartphone, laptop computer, desktop computer, tablet computer, etc. As discussed below, user devices such as 105, 110, and 115 may engage in various actions, including transactions, using transaction system 160. Machine learning system 120 may comprise one or more computing devices each having a processor and a memory, as may transaction system 160. Network 150 may comprise all or a portion of the Internet.

In various embodiments, machine learning system 120 can take operations related to creating, training, and maintaining a two-part machine learning system usable to determine a predicted likelihood of reversal for an electronic payment transaction. Note that different aspects of operations described relative to machine learning system 120 (as well as other systems described herein) can be performed by two or more different computer systems in some embodiments. Machine learning system 120 may be controlled by an entity who provides an electronically provided service, which may be an electronic transaction payment service in some instances (allowing for transfer of currency or other items).

Transaction system 160 may correspond to an electronic payment service such as that provided by PayPal™. Transaction system 160 may have a variety of associated user accounts allowing users to make payments electronically and to receive payments electronically. A user account may have a variety of associated funding mechanisms (e.g. a linked bank account, a credit card, etc.) and may also maintain a currency balance in the electronic payment account. A number of possible different funding sources can be used to provide a source of funds (credit, checking, balance, etc.). User devices 105, 110, and 115 can be used to access electronic payment accounts such as those provided by PayPal™. In various embodiments, quantities other than currency may be exchanged via transaction system 160, including but not limited to stocks, commodities, gift cards, incentive points (e.g. from airlines or hotels), etc.

Records database (DB) 130 includes records related to various transactions taken by users of transaction system 160. These records can include any number of details, such as any information related to a transaction or to an action taken by a user on a web page or an application installed on a computing device (e.g., the PayPal app on a smartphone). Many or all of the records in records database 130 are transaction records including details of a user sending or receiving currency (or some other quantity, such as credit card award points, cryptocurrency, etc.).

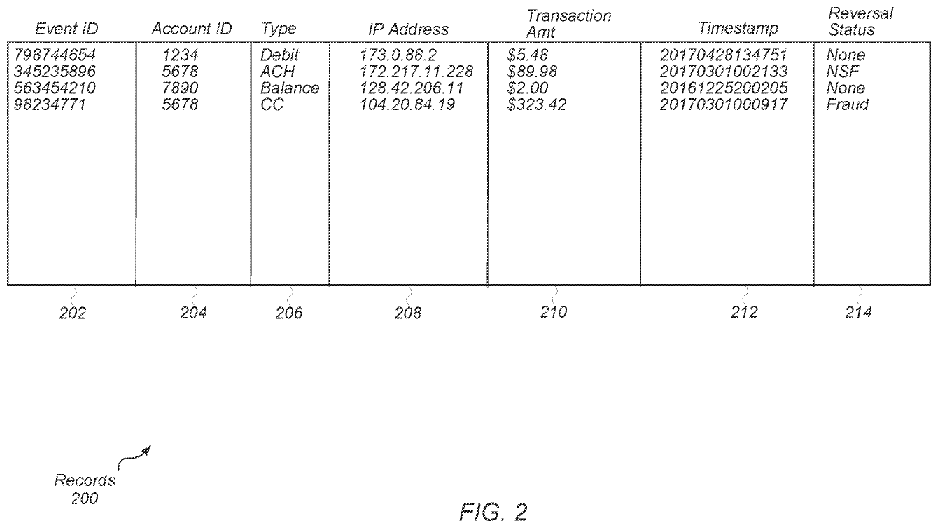

Turning to FIG. 2, a block diagram is shown of one embodiment of records 200. These records may be contained in records database 130, for example. In this example, the records shown include various charges made by different funding mechanisms.

As shown, field 202 includes an event ID. This may be a globally unique event identifier within an enterprise associated with transaction system 160. Thus, in one embodiment, the event ID in field 202 includes a unique ID for each of millions of electronic payment transactions processed by a service provider such as PayPal™. Field 204 includes a unique account ID for a user.

Field 206 includes type of transaction. In this example, rows 1 and 4 are a credit card (“CC”) funded transaction, while row 2 is an Automated Clearinghouse (ACH) funded transaction. Row 3 is a balance funded transaction (e.g. a user had a pre-existing currency balance in her account that was used to pay another entity). Additional types of transactions and/or more specific information is also possible in various embodiments (e.g., different types of credit card networks could be specified, such as VISA™ or MASTERCARD™).

Fields 208 and 210 represent an IP address and a transaction amount (which may be specified in a particular currency such as US Dollars, Great Britain Pounds, etc.). The IP address might be the IP address of the user at the time the transaction was conducted, for example. Field 212 includes a transaction timestamp. In the examples shown, the timestamps are in the format (year) (two-digit month) (two-digit day) (hour) (minute) (seconds), but may be in any other format in various embodiments.

Field 214 indicates a reversal status. In this example, rows 1 and 3 represent transactions that were not reversed (e.g. reversal status of “none”). Row 2 indicates a reversal status of “NSF”, or insufficient funds. Thus, field 214 for row 2 indicates that an ACH transaction of $89.98 was conducted, but that this transaction was later reversed when the source of funds used (e.g. a banking account) did not contain enough money to fund the transaction.

Meanwhile, row 4 indicates that a credit card transaction in the amount of $323.42 was reversed due to fraud. In a fraud case, a user's electronic payment transaction account may have been compromised by an unauthorized user who has gained access to the account. If that unauthorized user makes a charge using a credit card, debit card, or other funding instrument, then fraud may result. Fraud can be reported and/or detected through various mechanisms, including but not limited to user-initiated disputes and internal investigations.

The finality of the “reversal status” of a transaction in field 214 may depend on the length of time since a transaction occurred and the mechanism through which the transaction was conducted. In the case of debit card transactions, for example, some regulatory schemes require that a user report suspected fraud within certain time limits, e.g., 60 calendar days after an account statement is sent. Failure to report fraud within those limits may mean that the user is fully liable (rather than a bank or other party) for the fraudulent charges. Thus, under such a regulatory scheme, a debit card funded transaction that was 92 or more days old might be considered “fully seasoned” (because fraud reported after this date would not necessarily cause any loss to a bank or electronic payment transaction service provider), in some embodiments. Data may be considered seasoned, with respect to transaction reversal, based on a variety of different time limit thresholds (which may also vary funding source). In some instances, a time limit threshold for data to be considered seasoned may be a “hard” limit (e.g. as prescribed by legal regulations) or a “soft” limit (e.g. a time period beyond which consumers are fairly unlikely to report fraud).

Many additional pieces of information may be present in records database 130 in various embodiments. An email address associated with an account (e.g. which can be used to direct an electronic payment to a particular account using only that email address) can be listed. Home address, phone number, and any number of other personal details can be listed. Further, in various embodiments, databases may include event information on actions associated payment transaction, such as actions taken relative to a website, or relative to an application installed on a device such as the PayPal application on a smartphone. Database information can therefore include web pages visited (e.g., did a user travel to www.PayPal.com from www.eBay.com, or from some other domain?), order in which the pages were visited, navigation information, etc. Database information can include actions taken within an application on a smartphone such as the PayPal™ app. Database information can also include a location of where a user has logged into (authenticated) an account; unsuccessful login attempts (including IP address etc.); time of day and/or date of week for any event mentioned herein; funding sources added or removed and accompanying details (e.g. adding a bank account to allow currency to be added to or withdrawn from a user account), address or other account information changes, etc. In other words, a large variety of information can be obtained and used to determine the riskiness of a transaction (and this same information can be used to train a robust AI model and an adaptive AI model).

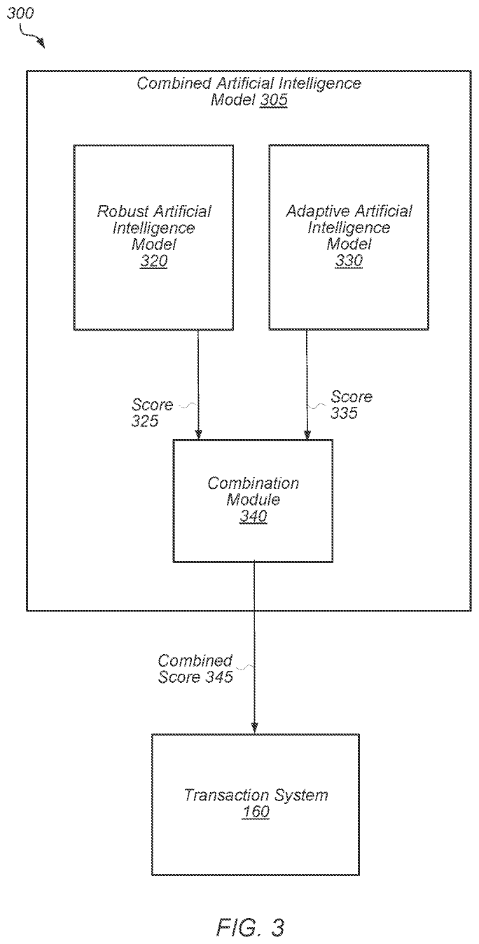

Turning to FIG. 3, a block diagram is shown of a system 300 relating to a combined artificial intelligence model that includes both a robust and an adaptive component. All aspects of this system may be implemented using computer software instructions, in various instances.

Combined artificial intelligence (AI) model 305 includes a robust AI model 320 and an adaptive AI model 330. Both these models may be trained using at least somewhat different data in various embodiments, and can each produce respective scores 325 and 335. These scores can be risk scores indicative, for a particular transaction, of a risk of reversal for that transaction (e.g., if that transaction is permitted by transaction system 160, what is the relative or absolute likelihood of the transaction being reversed due to fraud, NSF, or some other reason?).

Combination module 340 is used to combine scores 325 and 335 in the embodiment shown. Combination module 340 may use a static combination metric (e.g., a weighted average that is 60% robust AI model score and 40% adaptive AI model score), or may use different and/or more complex combination metrics in various embodiments. For example, a time of day, day of week, month of year, or other temporal basis could be used to adjust the weighting of the two scores. Perhaps the robust model performs especially well during the peak North American holiday shopping season in late November and December, for example, so a 70% weighting would be used for that time period). Or, it may be the case that the adaptive AI model performs relatively better during the period from 11 pm to 6 am, and its weighting could be boosted accordingly for this period. Spatial/geographic trends can also be analyzed for customizing the combined weighting the robust AI model 320 and adaptive AI model 330—for example, the models may perform slightly differently in certain states, prefectures, countries, time zones, continents, etc., and combination module 340 could use these factors to adjust weighting accordingly when producing combined score 345. Note that procedures used to train robust AI model 320 and adaptive AI model 330 are discussed in more detail below.

Combined score 345 can be provided to transaction system 160 in order for transaction system 160 to decide whether to approve or deny a transaction, in various embodiments. In some cases, the combined score 345 may be the entire basis for approval or denial of a transaction by transaction system 160, while in other embodiments, transaction system 160 may use additional information and/or algorithms to decide whether to allow a transaction to proceed. (In various cases, an entity associated with transaction system 160 may assume partial or total liability for charges resulting from transaction reversal, hence the need to assess transaction risk.)

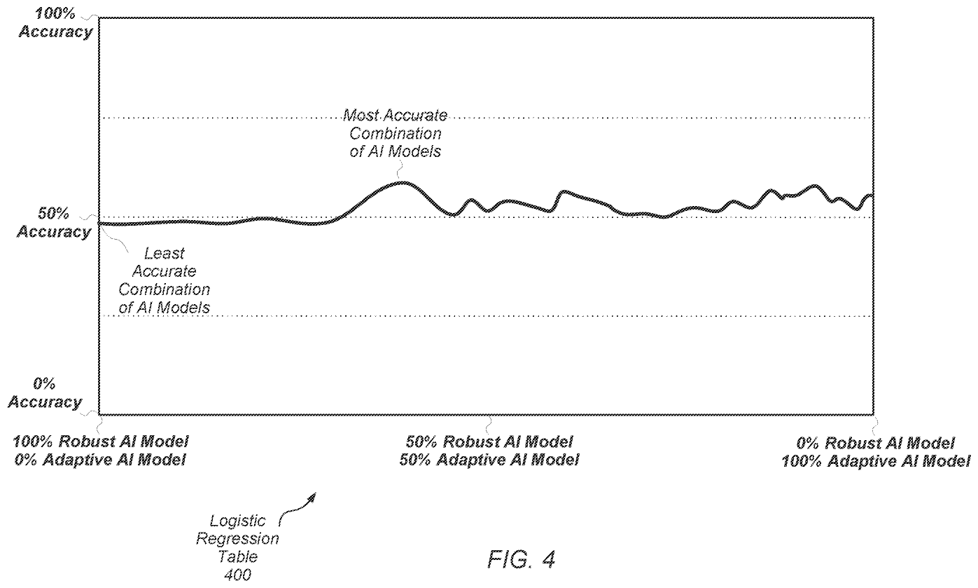

Turning to FIG. 4, a chart diagram of a logistic regression table 400 is shown, according to some embodiments. This chart illustrates how overall accuracy of assessing transaction risk can be impacted by varying combined weights for robust AI model 320 and adaptive AI model 330. (Note that in this example, temporal, spatial, and other factors are not explicitly considered, as the chart is global, but similar data looking at smaller transaction segments (e.g. transactions from one country, at certain time periods etc.) can be analyzed as desired.)

For logistic regression table 400, average weightings of robust AI model 320 and adaptive AI model 330 are used, with relative weightings between 0 and 100 for each model. On the far left of the X-axis, the weighting is 100% robust AI model 320, while the far right is 100% adaptive AI model 330. Accuracy is shown on the Y-axis (e.g., what percentage of later reversed charges were predicted by the combined model weighting indicated on the X-axis).

As can be seen, in this example, a mix of roughly 60% adaptive AI model 320 and 40% robust AI model 330 provides the best performance against sample data. Meanwhile, the least accurate performance is using 100% of robust AI model 320 (with no weighting for adaptive AI model 330). These figures are only used for illustration, however, and could vary widely by embodiment and depending on the type(s) of underlying transaction data used.

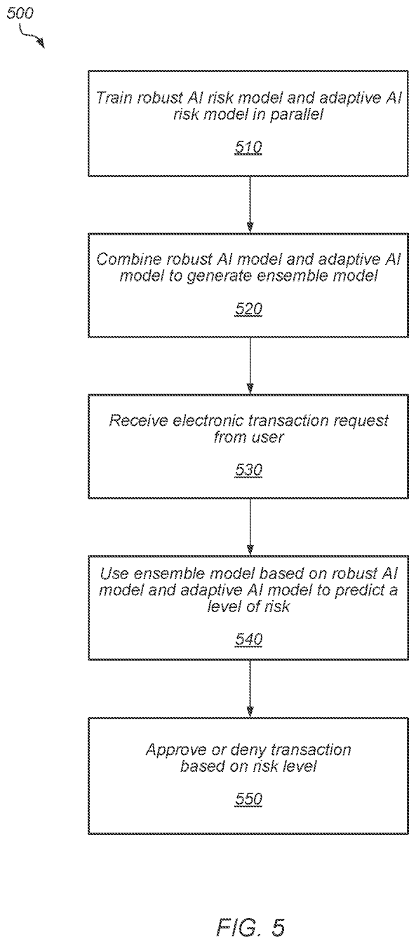

Turning now to FIG. 5, a flow diagram is shown illustrating one embodiment of a method 500 that relates to constructing, training, and operating an artificial intelligence system that includes two different components, a robust AI model and an adaptive AI model. This artificial intelligence system architecture may be used to analyze a variety of data, including but not limited to electronic payment transactions.

Operations described relative to FIG. 5 may be performed, in various embodiments, by any suitable computer system and/or combination of computer systems, including machine learning system 120 and/or transaction system 160. For convenience and ease of explanation, however, operations described below will simply be discussed relative to machine learning system 120. Further, various elements of operations discussed below may be modified, omitted, and/or used in a different manner or different order than that indicated. Thus, in some embodiments, machine learning system 120 may perform one or more aspects described below, while transaction system 160 (or another system) might perform one or more other aspects.

In operation 510, machine learning system 120 trains a robust AI risk model such as robust AI model 320 and an adaptive AI risk model such as adaptive AI model 330, in various embodiments. This training may be performed in parallel in various embodiments and include accessing seasoned transaction data that includes records of a plurality of electronic payment transactions. The data accessed in operation 510 may thus be stored in records database 130, in some embodiments.

Each of the records in the seasoned transaction data may contain an indication about whether a corresponding electronic payment transaction for that record was reversed. Thus, for example, an ACH funded electronic payment transaction may have an indicator stating that the ACH transaction was reversed for insufficient funds (NSF), or may have an indicator that the transaction has not been reversed. (In some cases, the fact that a transaction has not been reversed may be inferred from a lack of any other indicator that the transaction was in fact reversed). A credit card or debit card funded transaction may contain an indicator that the transaction was charged back (reversed) by the user for fraud/unauthorized use reasons. A balance-funded transaction (e.g. a PayPal™ transaction funded by a balance in a PayPal™ account) might also have an indicator that the transaction was reversed for fraud/unauthorized use (e.g., a user's account might have been taken over by someone who is not supposed to have access). As discussed above, many different reversal statuses for different transactions are possible, and are not limited to the examples above (e.g., an ACH transaction could be reversed for fraud as well).

The seasoned transaction data accessed in operation 510 may also be aged past a certain time threshold, in various embodiments. Multiple different thresholds can also be used for different types of transaction data, e.g., credit card funded transactions might be considered “seasoned” after a first amount of time such as 90 days, debit card funded transactions might be considered “seasoned” after 60 days, while account balance-funded transactions would be considered seasoned after only 45 days. Many different time thresholds may be used to determine whether transaction data is considered seasoned, but in various embodiments, the general notion is that for data to be considered seasoned, some passage of time must have occurred such that there is some amount of confidence that a transaction is considered settled and will not be later reversed.

Still referring to operation 510, a robust AI risk model is trained using the set of seasoned transaction data, in various embodiments, such that after training the robust AI risk model is usable to predict risk of reversal for future unknown electronic payment transactions. Thus, after training on known data (where there is an indication of whether the transaction was reversed due to fraud and/or another reason), the robust AI risk model may be able to provide an estimation as to whether a given future transaction is likely to be reversed. This estimation can be used to determine whether the transaction should ultimately be approved or denied.

Training the robust AI risk model in operation 510 may include training a gradient-boosting tree (GBT) model, an artificial neural network (ANN) model, or other types of machine learning models in various embodiments. Thus, in one embodiment, training data comprising seasoned transaction data is input into a GBT model having particular internal parameters (which may be constructed/determined based on the transaction data). Output of the GBT model having the particular internal parameters can then be repeatedly compared to known reversal outcomes of the seasoned transaction data, and the GBT model can be altered based on the comparing to refine accuracy of the GBT model. For example a first decision tree can be calculated based on the known data, then a second decision tree can be calculated based on inaccuracies detected in the first decision tree. This process can be repeated, with different weighting potentially given to different trees, to produce an ensemble of trees with a refined level of accuracy significantly above what might be produced from only one or two particular trees.

Accordingly, in other embodiments, an artificial neural network (ANN) model is trained to produce a robust AI risk model. Internal parameters of the ANN model (e.g., corresponding to mathematical functions operative on individual neurons of the ANN) are then varied. Output from the ANN model is then compared to known results, during the training process, to determine one or more best performing sets of internal parameters for the ANN model. Thus, many different internal parameter settings may be used for various neurons at different layers to see which settings most accurately predict whether a particular transaction is likely to be reversed (e.g. due to fraud). In addition to the GBT and ANN models outlined above, other forms of machine learning may also be used to construct the robust AI risk model that is trained in operation 510.

Training an adaptive AI risk model such as adaptive AI model 330, in various embodiments, may use at least one different set of electronic payment transaction data, where the different set of data contains at least one data feature that is not present in the set of seasoned transaction data.

One concept behind the use of an adaptive AI risk model is that the adaptive model may use newer data for which there may not be as long of a track record as for the seasoned transaction data used to train the robust AI risk model. The adaptive AI risk model can thus be more speculative, in some instances, and try to take advantage of shorter term trends or events that may not be effectively captured by the robust AI risk model. Training the adaptive AI risk model may make the adaptive AI risk model suable to predict risk of reversal for future unknown electronic payment transactions.

The at least one data feature that is not present in the set of seasoned transaction data can be for a new type of transaction data in various embodiments. This data feature might correspond to an action taken on a web page. For example, a website might change its purchase flow (e.g. the sequence of web pages and actions taken on those web pages). A user might have to select different buttons or other user web interface elements in order to consummate a purchase. New data might therefore be available that was not previously present in other seasoned transaction data. After analysis, it may be the case that certain transactions are more likely to be reversed (e.g. due to fraud) based on differences that can be detected in the new data.

Another data feature not present in the set of seasoned transaction data, but used to train the adaptive AI risk model, could be transaction data that corresponds to a hardware or software feature of a mobile phone device (or other device). For example, if a previously unavailable mobile phone device was released that featured a new way to authenticate a user for transactions, such as facial recognition, fraudsters might attempt to defeat or corrupt this mechanism in certain new ways. A software feature on a mobile phone device might also change such that the phone operates in a way different than before. These changes can generate new data previously unavailable, and any such new data may be indicative of a likelihood of transaction reversal after analysis is performed.

Unlike the robust AI risk model in various embodiments, the adaptive AI risk model training process uses unseasoned data that is younger than a threshold age limit. Thus, the seasoned data might all be a certain number of days old in some cases, while the unseasoned data could include younger data. This allows the adaptive AI risk model to be trained on more recent data, allowing it to pick up on reversal (e.g. fraud) trends that are newer and less established. Such trends may nonetheless cause significant losses to be incurred, particularly because they may be harder to detect using a robust AI risk model. As discussed further below, the adaptive AI risk model may also be re-trained more frequently than the robust AI risk model (e.g. once every week, two weeks, month, 3 months etc., rather than a longer period such as 3 months, 6 months, or a year for the robust AI risk model). This can allow the adaptive AI risk model to stay on top of more recent trends. The combination of the robust AI risk model with the adaptive AI risk model, however, can prevent longer term trends in risk of reversal from being ignored or underweighted.

Training the adaptive AI risk model can be accomplished similarly to training the robust AI risk model (although at least somewhat different data is generally used). The adaptive AI risk model can be implemented as a gradient boosting tree model, an artificial neural network, or can be implemented using another machine learning construct. Training the adaptive AI risk model can thus include comparing predictions from the risk model to known outcomes for the training data, and tweaking various parameters until one or more best performing versions of the risk model are discovered.

In operation 520, the robust AI model and the adaptive AI model are combined to generate an ensemble model, in various embodiments. This ensemble model may thus have a robust portion and an adaptive portion that are used in combination to generate predictions. As described herein, the combination may involve weighting the robust portion according to a first factor and weighting the adaptive portion according to another factor.

In operation 530, machine learning system 120 receives an electronic transaction request from a user in various embodiments. This request may be to pay an amount of currency (or other quantity) to another user. Various information may accompany the request—type of device, user ID, IP address, etc. In general, any feature data used to train the robust and/or adaptive AI risk models can accompany the electronic transaction request. (Note that operation 530, as with all operations of method 500, can be performed by transaction system 160 in various embodiments.)

In operation 540, machine learning system 120 uses an ensemble model based on a robust AI risk model and an adaptive AI risk model to predict a level of risk for the electronic transaction in various embodiments. This risk level may be based on both longer term risk of reversal trends, as analyzed by robust AI model 320, as well as shorter term risk of reversal, as analyzed by adaptive AI model 330, for example, in some embodiments.

Using the ensemble model may include feeding a sample data value for the at least one data feature that is not present in the set of seasoned transaction data to the adaptive AI risk model component, in various embodiments, while the robust AI risk model component uses slightly different data (e.g. does not use a newer data feature).

The level of risk output by the ensemble model may be based on a combination using a first weighting value for the robust component and a second weighting value for the adaptive component. These first and second weighting values may be determined from training a combination of the robust AI model and the adaptive AI model. Training the combination of the robust and adaptive models can be done as a logistic regression, for example (see, e.g., FIG. 4, illustrating accuracy of various weightings for the robust model and the adaptive model). For example 100 (or some other number) of different weightings of the adaptive and robust models can be used, with the best resulting combination being used to predict risk of reversal for future unknown transactions.

In operation 550, machine learning system 120 (and/or transaction system 160) approves or denies the electronic transaction based on the overall risk level, in various embodiments. In addition to the assessed risk level additional factors can also be used to determine approval or denial, in some instances. For example, the size of the transaction may affect approval—a risky transaction for $1.25 may be approved while a similarly risky transaction for $1000.00 might be denied.

In some embodiments, method 500 further includes machine learning system 120, subsequent to training the robust AI risk model and the adaptive AI risk model, receiving a new type of transaction data that was not previously used to train either the robust or adaptive AI risk model and using the new type of transaction data to re-train the adaptive AI risk model but not the robust AI risk model. As discussed above, new types of data may become available based on new hardware or software features for a device, or changes to a software application (e.g. a mobile phone app such as the PayPal™ app) or to a web page checkout flow used to make an electronic transaction. This data can be used to update the adaptive risk model at an earlier time than the data might be used for the robust risk model (e.g. because that new data is not deemed sufficiently seasoned for the robust model and/or the robust model is not going to be re-trained as frequently as the adaptive model). Thus, the adaptive model can be changed to reflect new trends and new data more quickly than the robust model, allowing shifting trends to be taken into account and more accurately detect risk of transaction reversal than only using a robust model (or adaptive model) approach.

### Computer-Readable Medium

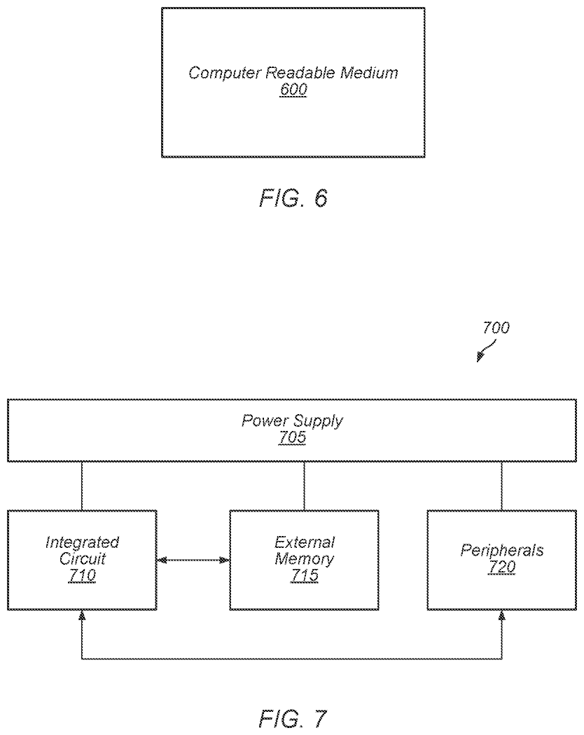

Turning to FIG. 6, a block diagram of one embodiment of a computer-readable medium 600 is shown. This computer-readable medium may store instructions corresponding to the operations of FIG. 5 and/or any techniques described herein. Thus, in one embodiment, instructions corresponding to machine learning system 120 may be stored on computer-readable medium 600.

Note that more generally, program instructions may be stored on a non-volatile medium such as a hard disk or FLASH drive, or may be stored in any other volatile or non-volatile memory medium or device as is well known, such as a ROM or RAM, or provided on any media capable of staring program code, such as a compact disk (CD) medium, DVD medium, holographic storage, networked storage, etc. Additionally, program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as VBScript. Note that as used herein, the term “computer-readable medium” refers to a non-transitory computer readable medium.

### Computer System

In FIG. 7, one embodiment of a computer system 700 is illustrated. Various embodiments of this system may be machine learning system 120, transaction system 160, or any other computer system as discussed above and herein.

In the illustrated embodiment, system 700 includes at least one instance of an integrated circuit (processor) 710 coupled to an external memory 715. The external memory 715 may form a main memory subsystem in one embodiment. The integrated circuit 710 is coupled to one or more peripherals 720 and the external memory 715. A power supply 705 is also provided which supplies one or more supply voltages to the integrated circuit 710 as well as one or more supply voltages to the memory 715 and/or the peripherals 720. In some embodiments, more than one instance of the integrated circuit 710 may be included (and more than one external memory 715 may be included as well).

The memory 715 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 710 in a chip-on-chip configuration, a package-on-package configuration, or a multi-chip module configuration.

The peripherals 720 may include any desired circuitry, depending on the type of system 700. For example, in one embodiment, the system 700 may be a mobile device (e.g. personal digital assistant (PDA), smart phone, etc.) and the peripherals 720 may include devices for various types of wireless communication, such as wifi, Bluetooth, cellular, global positioning system, etc. Peripherals 720 may include one or more network access cards. The peripherals 720 may also include additional storage, including RAM storage, solid state storage, or disk storage. The peripherals 720 may include user interface devices such as a display screen, including touch display screens or multitouch display screens, keyboard or other input devices, microphones, speakers, etc. In other embodiments, the system 700 may be any type of computing system (e.g. desktop personal computer, server, laptop, workstation, net top etc.). Peripherals 720 may thus include any networking or communication devices necessary to interface two computer systems.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An artificial intelligence-based assessment system, comprising:
a processor; and
a memory having stored thereon instructions that are executable by the processor to cause the system to perform operations comprising:
training a robust artificial intelligence (AI) risk model using a set of seasoned transaction data, wherein the robust AI risk model is usable to predict risk of reversal for future unknown electronic payment transactions, and wherein the seasoned transaction data comprises records of a plurality of electronic payment transactions, wherein each of the records contains an indication about whether a corresponding electronic payment transaction for that record was reversed;
training an adaptive AI risk model using at least one different set of electronic payment transaction data, wherein the different set contains at least one data feature that is not present in the set of seasoned transaction data, and wherein the adaptive AI risk is usable to predict risk of reversal for future unknown electronic payment transactions based at least in part on unseasoned data that is younger than an aging threshold limit;
creating an ensemble model based on a combination of the robust AI risk model and the adaptive AI risk model;
receiving an electronic transaction request from a user;
using the ensemble model to predict a level of risk for the electronic transaction; and
approving or denying the electronic transaction based on the overall risk level.

2. The system of claim 1, wherein the operations further comprise, subsequent to training the robust AI risk model and the adaptive AI risk model:
receiving a new type of transaction data that was not previously used to train either the robust or adaptive AI risk model;
using the new type of transaction data to re-train the adaptive AI risk model but not the robust AI risk model; and
creating an updated ensemble model using the re-trained adaptive AI risk model.

3. The system of claim 1, wherein the robust AI risk model and the adaptive AI risk model are trained in parallel.

4. The system of claim 2, wherein the new type of transaction data corresponds to a hardware or software feature of a mobile phone device.

5. The system of claim 1, wherein the seasoned transaction data comprises credit card transaction data that includes only records of transactions that occurred at least a particular period of time in the past, and wherein the credit card transaction data includes an indication whether a particular transaction had a chargeback occur.

6. The system of claim 1, wherein training the robust AI risk model comprises:
inputting test data, comprising the seasoned transaction data, into a gradient boosted tree (GBT) model having particular internal parameters; and
repeatedly comparing output of the GBT model to known reversal outcomes of the seasoned transaction data, and altering the GBT model based on the comparing to refine accuracy of the GBT model.

7. The system of claim 1, wherein training the robust AI risk model comprises:
inputting test data, comprising the seasoned transaction data, into an artificial neural network (ANN) model having particular internal parameters;
varying the internal parameters of the ANN model; and
comparing outputs of the ANN model under the varied internal parameters to determine one or more best performing sets of internal parameters for the ANN model.

8. The system of claim 1, wherein the operations further comprise:
training the combination of the robust AI model and the adaptive AI model using a logistic regression.

9. The system of claim 8, wherein the logistic regression using a first weighting value for the robust AI model and a second weighting value for the adaptive AI model.

10. A method, comprising:
receiving, at a computer system, an electronic transaction request from a user;
using an ensemble artificial intelligence (AI) risk model to predict a level of risk for the electronic transaction, wherein the ensemble AI risk model is based on a combination of a robust AI risk model and an adaptive AI risk model, wherein the ensemble AI risk model is usable to predict risk of reversal of electronic payment transactions,
wherein the robust AI risk model was trained using a set of seasoned transaction data comprising records of a plurality of electronic payment transactions, wherein each of the records contains an indication about whether a corresponding electronic payment transaction for that record was reversed,
wherein the adaptive AI risk model was trained using at least one different set of electronic payment transaction data, wherein the different set contains at least one data feature that is not present in the set of seasoned transaction data, and wherein the adaptive AI risk is usable to predict risk of reversal of electronic payment transactions;
determining, by the computer system from the ensemble AI risk model, a risk level for the electronic transaction; and
approving or denying, by the computer system, the electronic transaction based on the risk level.

11. The method of claim 10, wherein training the adaptive AI risk model comprises:
inputting test data, comprising at least a portion of the seasoned transaction data and the at least one different set of electronic payment transaction data, into a gradient boosted tree (GBT) model having particular internal parameters; and
repeatedly comparing output of the GBT model to known reversal outcomes of the seasoned transaction data, and altering the GBT model

12. The method of claim 11, wherein the GBT model uses an ensemble of at least ten different boosted trees.

13. The method of claim 10, wherein training the adaptive AI risk model comprises:
inputting test data, comprising the seasoned transaction data, into an artificial neural network (ANN) model having particular internal parameters;
varying the internal parameters of the ANN model; and
comparing outputs of the ANN model under the varied internal parameters to determine one or more best performing sets of internal parameters for the ANN model.

14. The method of claim 10, wherein the seasoned transaction data comprises automated clearinghouse (ACH) transaction data that includes only records of transactions that occurred at least a particular period of time in the past, and wherein the ACH transaction data includes an indication whether a particular transaction was reversed.

15. The method of claim 10, further comprising re-training the adaptive AI risk model using a new type of transaction data, but not re-training the robust AI risk model; and
determining a level of risk for a new electronic payment transaction using the re-trained adaptive AI risk model and the robust AI risk model.

16. The method of claim 15, wherein the new type of transaction data corresponds to one or more user actions taken within a customized software application installed on a smartphone by an electronic transaction payment service provider.

17. The method of claim 15, wherein the new type of transaction data corresponds to a newly available device hardware feature that was not in existence at the time the robust AI risk model was trained.

18. A non-transitory computer-readable medium having stored thereon instructions that are executable by a system to cause the system to perform operations comprising:
receiving an electronic transaction request from a user;
using an ensemble artificial intelligence (AI) risk model to predict a level of risk for the electronic transaction, wherein the ensemble AI risk model is based on a combination of a robust AI risk model and an adaptive AI risk model, wherein the ensemble AI risk model is usable to predict risk of reversal of electronic payment transactions,
wherein the robust AI risk model was trained using a set of seasoned transaction data comprising records of a plurality of electronic payment transactions, wherein each of the records contains an indication about whether a corresponding electronic payment transaction for that record was reversed,
wherein the adaptive AI risk model was trained using at least one different set of electronic payment transaction data, wherein the different set contains at least one data feature that is not present in the set of seasoned transaction data, and wherein the adaptive AI risk is usable to predict risk of reversal of electronic payment transactions;
determining, from the ensemble AI risk model, a risk level for the electronic transaction; and
approving or denying the electronic transaction based on the risk level.

19. The non-transitory computer-readable medium of claim 18, wherein the adaptive AI risk model and the robust AI risk model are of differing machine learning model types.

20. The non-transitory computer-readable medium of claim 18, wherein the operations further comprise training the combination of the robust AI model and the adaptive AI model using a logistic regression.
